(19) United States
(12) Patent Application Publication
(10) Pub. No.: US 2005/0262222 A1
(43) Pub. Date: Nov. 24, 2005

(54) Method for updating services in communication networks

(76) Inventors: Ralf Neuhaus, LUNEN (DE); Rainer Uecker, Mulheim (DE)

Correspondence Address: Siemens Corporation;Intellectual Property Department, 170 Wood Avenue South, Iselin, NJ, 08830, US

(21) Appl. No.: 10/520,700

(22) PCT Filed: Jun. 6, 2003
(86) PCT No.: PCT/DE03/01896

§ 371 Date: Jan. 7, 2005

(30) Foreign Application Priority Data
Jul. 8, 2002 (DE) 102 30 690.7

(51) Int. Cl. G06F 15/177

(52) U.S. Cl. 709/220

(57) ABSTRACT

The invention is based on a communication network containing components which use and provide services in the communication network, a plurality of components being able to provide the same service. One component determines the services provided by other components in the communication network. Where the same services are provided by two components, information relating to the output state of the software controlling the services is exchanged between the components and compared. A software update is initialised if the output states differ. If a defined service is activated in a second component by means of a first component, but the service cannot be provided by means of the software of the second component although the second component has the necessary hardware requirements therefore, said service is made available by updating the software of the second component.

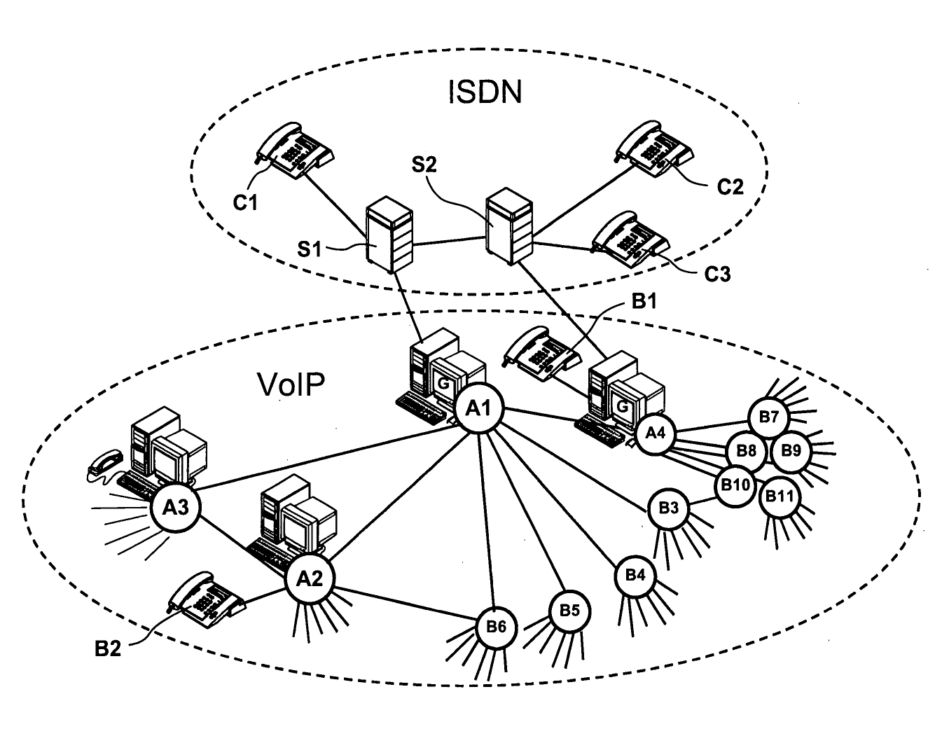

### CROSS REFERENCE TO RELATED APPLICATIONS

This application is the US National Stage of International Application No. PCT/DE03/01896, filed Jun. 6, 2003 and claims the benefit thereof. The International Application claims the benefits of German application No. 10230690.7 DE filed Jul. 8, 2002, both of the applications are incorporated by reference herein in their entirety.

### FIELD OF INVENTION

This invention refers to a method for updating services in a communication network.

### BACKGROUND OF INVENTION

Communication networks whose components communicate with one another on a packet-switched basis are replacing circuit-switching communication networks to an increasing extent. Such networks are frequently also referred to as Voice over IP (VoIP for short) networks when the Internet protocol (IP) is used for interchanging the audio information provided in the form of data. In this case, the networks may either be used exclusively for transmitting voice data or else for transmitting a mixture of voice data and other information.

The interconnected devices arranged in communication networks are referred to generally as communication components. When a communication component of this type is used as a terminal, for example as a telephone or a multimedia terminal, this component is also referred to as a client component. Other components are not used as a terminal, but rather provide services in the communication network. The services may be a gateway functionality, a voicemail server, an address directory or the like, for example. Such communication components are also referred to as server components.

Both the client components and the server components normally comprise a piece of computer hardware (for example a PC) which uses appropriate hardware extensions and a piece of adapted software to perform appropriate functionalities and provide services. In this case, the performance of a communication component is frequently dependent on the presence and release of the installed software, which means that by updating a piece of software which has already been installed or by freshly installing a piece of software which has not been present to date, it is possible to increase the performance of a communication component significantly.

A piece of computer hardware may also have more than one software application installed on it, which means that a single physical component in the network may in principle exercise both client and server functionalities. Such communication components are also referred to as servents in the literature, an artificial word derived from the terms “client” and “server”.

The communication components connect to one another by interchanging addressed data packets with one another. In this case, each communication component in the packet-switching communication network has a network address which is uniquely associated with it. In the networks which interchange data on the basis of the Internet protocol (IP networks), this is the IP address and the IP port number, for example. If a communication component is intended to connect to or interchange data with another communication component, then it is first necessary to find out the network address of the other component. The network addresses are not always permanently associated with the communication components over time, but rather may also be allocated dynamically in the network, which means that communication components may each have a different address whenever they have been turned off and turned on again or after predetermined events. For this reason, at least one network component in the known packet-switching communication networks is equipped with an address directory (address database) for all of the communication components which are available in this network. These server components are normally referred to as gatekeepers.

Alternatively, data interchange without a central address database in the manner of a gatekeeper is known, for example using the “The Gnutella Protocol Specification V 0.4” method, which communication components on the Internet can automatically use to find other communication components for file interchange. In this case, the file and hence data interchange thus takes place not using a central server component or a “gatekeeper”, but rather directly between the individual components. Networks which provide direct data interchange between communication components without a superordinate entity are called peer-to-peer networks. The communication components which comprise both “client” and “server” functionalities are the aforementioned “servents”.

In the peer-to-peer network based on the Gnutella specification, each communication component (for example a PC) holds files ready for interchange with other communication components. In order to be able to interchange data, the searching communication component requires the network address of the communication component which holds the sought file ready for retrieval. To this end, it first of all sends a first search message, the “ping”. Communication components which receive a “ping” search message respond to the searching communication component using a hit response, the “pong”. This hit response contains the respective network address of the responding communication component and the number of files which this communication component provides for interchange.

In the next step, the searching communication component sends a second search message “Query” to a limited selection of those communication components which have responded to the “ping” search message with a “pong”. The second search message already contains the file name of the file which is being sought. If a communication component receives a second search message “Query” but does not itself hold the sought file ready for interchange, then it forwards this search message to other communication components in the network whose addresses it has ascertained, for example by means of a “ping” method which has already been carried out in the past. If the communication component can provide the desired file for interchange, however, then it responds to the second search message “Query” with a hit response “Query Hit”, as a result of which the searching communication component can initiate the file transfer using commands defined in the Internet protocol.

The Gnutella method is used when a particular file is being sought among other communication components. The search method is terminated at the very instant at which the sought file has been found for the first time.

While the correct file need only be found once when searching on the basis of the Gnutella method, it is frequently important in the case of the services in communication networks to gain access to a plurality of communication components—providing services of the same type—in order to be able to choose between them when required.

A further drawback of the known method is that although useful data can be interchanged between communication components there is no guarantee that the software used on the communication components is sufficient for processing the useful data or is sufficiently up-to-date.

In addition, the known method does not allow the software installed on a communication component to be modified.

### SUMMARY OF INVENTION

It is an object of the invention to improve the performance of software-controlled communication components arranged in packet-switching communication networks.

The object is achieved by the features of the claims.

The invention is based on a communication network, particularly a packet-switching network, which contains communication components which use and provide services in the communication network, with a plurality of communication components being able to provide an identical—software-controlled—service.

In this case, a communication component ascertains the services provided in the communication network by other communication components. In cases in which both communication components provide identical services, the communication components interchange and compare information about the release of the software controlling the services. If the releases are different, a software update is initialized.

If a first communication component needs to activate a particular service in a second communication component but this service cannot be provided by the software on the second communication component, even though the hardware requirements necessary for this service are in place in the second communication component, this service is made available by a software update on the second communication component.

One advantage of the inventive method is that the methods can be implemented with little complexity in already existing systems.

Advantageous refinements of the invention are specified in the claims.

By virtue of at least one communication component providing software in a respective up-to-date release for retrieval for a plurality of services, it is a simple matter to ensure that the most up-to-date software version is always present in the entire communication network. This reduces the administration complexity for the communication network to a considerable extent.

### BRIEF DESCRIPTION OF THE DRAWING

An exemplary embodiment of the inventive method is described below with reference to the drawing.

To this end, the single FIGURE shows a schematic illustration of a packet-switching communication network which is connected to a circuit-switching communication network.

### DETAILED DESCRIPTION OF INVENTION

A packet-switching communication network VoIP contains communication components A1-A4, B1-B11 connected to one another.

The communication components A1-A4, B3-B11 are servents which thus have both client and server functionalities. The communication components B1, B2 are “simple” IP telephones, that is to say communication components with pure client functionality.

The communication components A1, A4 contain, as a server functionality, gateways which connect the packet-switching communication network VoIP to the circuit-switching communication network ISDN. The gateways installed on the communication components A1 and A4 are situated at various locations and also in different secondary distribution network areas of the circuit-switching communication network ISDN. The gateways permit connections between the communication components A1-A4, B1-B11 in the packet-switching communication network VoIP and the circuit-switching communication system S1, S2, to which ISDN terminals C1-C3 are connected. They are available as usable resources to all client components in the packet-switching communication network VoIP and also to the communication installations S1, S2 in the circuit-switching communication network ISDN.

The gateways installed on the communication components A1, A4 may be selected and used by the client components of the communication components B1, B2 and also by all client components installed in the packet-switching communication network VoIP on the communication components A1-A4, B3-B11—predominantly in the form of software applications. To this end, all communication components A1-A4, B3-B11 have a piece of communication software installed on them which provides the client functionality.

The communication software is designed such that it also respectively examines its own communication component A1-A4, B3-B11 to determine which server functionalities can be provided. This is done at least when the communication software is started for the first time. This information regarding the server functionalities is then stored such that it can be retrieved by the other communication components A1-A4, B3-B11 using appropriate search methods.

The text below uses the example of the communication component A3 to describe the search for services in the packet-switching communication network VoIP, the selection of one of a plurality of gateways as services and the use of the selected gateway for the purpose of a communication connection between the communication component A3 and the ISDN terminal C1 in the circuit-switching communication network ISDN.

When the communication component A3 has started and the above-described examination of the dedicated hardware has taken place, the client component of the communication component A3 searches the packet-switching communication network VoIP for other, “adjacent” communication components. To this end, methods defined in the Internet protocol are used which request all components in a network segment to send a response message. This is done by means of a “broadcast”, that is to say a message sent to all components which can be reached. In the course of this search, the communication component A3 ascertains and stores the network addresses of the communication components A1 and A2. In the next step, the communication component A3 sends search messages containing the demand for services of a particular type, namely for gateways, to the “adjacent” communication components A1 and A2 found.

The communication component A3 has been preset such that it uses this search method to search only for services of such a type which will probably or empirically be used more frequently. These include gateways which allow connections between the packet-switching communication network VoIP and the circuit-switching communication network ISDN. Other services which are used less often, for example servers for conducting telephone conferences, are sought in the packet-switching communication network VoIP only when the client component installed on the communication component A3 demands the use of such a service.

In this example, the communication software for the communication component A3 in the packet-switching communication network VoIP searches exclusively for gateways, because this is the service type used most often in this case.

The communication component A2 does not have its own gateway, which means that it forwards the search query from the communication component A3 to further communication components A4, B5, B6 itself.

By contrast, the communication component A1 has a gateway of its own and responds to the search query from the communication component A3 with a positive response which includes the network address of the communication component A1 and the access parameters for the gateway installed thereon. These statements are stored in a table by the communication component A3.

In addition, the communication component A1 forwards the search message to other communication components B3, B10, B11 which are known to it.

The communication component A4 likewise has a gateway of its own, which means that it responds to the search query from the communication component A3, which it has received via the “detour” through the communication component A2, in the same way, with the response comprising the network address of the communication component A4 and the access parameters for the gateway installed thereon, in a similar manner to the case of the communication component A1. These statements are also stored in the table of available gateways by the communication component A3.

The search messages which are forwarded from the communication component A3 to its adjacent communication components A1 and A2 and from these in turn to further communication components contain, in a predefined data field, a number which is reduced by 1 as a counter whenever the search message is forwarded from one communication component to the next communication component. As soon as this number has reached the value 0 as a result of continued forwarding of the search message, the search message is no longer transferred further in the packet-switching communication network VoIP. This prevents the search message from being forwarded infinitely often. The start value for this counter is set to be sufficiently high in the communication component A3, which means that a large portion of the packet-switching communication network VoIP or the entire packet-switching communication network VoIP is searched. In this case, the number has the value 10, for example.

Besides from the communication components A1 and A4, the communication component A3 receives no further responses.

The communication components A1-A4, B1-B11 in the packet-switching communication network VoIP are usually PCs or other data processing devices which obtain their client and also their server functionality essentially by virtue of them being installed with an appropriate piece of software. While alterations are rarely made to the hardware of the data processing devices following installation, software changes are more frequent. These software changes are frequently referred to as updates in the literature.

In the present exemplary embodiment it is assumed that the two gateways installed on the communication components A1 and A4 use the same hardware, that is to say have the same ISDN cards for connecting to the circuit-switching communication network ISDN, but have different releases (versions) of the installed control software. The reason for this, for example, is that the communication component A4 was not added to the packet-switching communication network VoIP until later and therefore has a newer software version.

In a similar manner to the method described for the communication component A3, the communication component A1 also searches the other communication components A2 to A4, B3 to B11 in the packet-switching communication network VoIP for services when it starts, but also later at regular intervals of time. Within the context of this search, the communication component A1 is notified of the network address of the communication component A4 and of the access parameters of the gateway installed on the communication component A4. The access parameters of the gateway for the communication component A4 also comprise details about the release of the control software used there. The communication software installed on the communication component A1 now establishes that the “gateway” server component located on the communication component A4 is the same service with the same hardware as its own gateway.

Subsequently, the communication component A1 compares the releases of the two software versions and establishes that the software version of the “foreign” gateway is more up-to-date. The communication component A1 then prompts a software download for this control software to its own communication component A1. In this case, the control software may be sent to the communication component A1 from the communication component A4 or alternatively from any other communication component providing the control software for the service.

In addition to updating a software version which is already present, the inventive method also permits automatic fresh installation of a piece of software which has not yet been installed on a communication component but is currently required.

In the text below, it is assumed that, by way of example, the communication component A2 calls the communication component A3, but the call is not taken on the communication component A3. The communication component A2 then attempts to activate the “callback” service, which is known on the communication component A2, on the communication component A3. The “callback” service cannot be performed by the communication component A3, however, since the control software required for this is not installed on the communication component A3. The communication component A3 then sends a message containing this information to the communication component A2 and checks whether the software required for the desired service can be obtained from the communication component A2. If so, a check is performed to determine whether the communication component A3 meets the hardware requirement for operating this software.

If all these requirements have been met, the software is sent from the communication component A2 to the communication component A3 and the “callback” service is activated on the communication component A3.

As an alternative to obtaining the control software from the communication component A2, the control software for the desired service may also be downloaded from any other communication component A1, A4, B3-B11. Of these communication components A1, A4, B3-B11, one may also be used specifically for distributing control software and may provide a multiplicity of different services with the respective up-to-date control software for different hardware platforms.

In addition to bringing the software versions into line during the search for services in the packet-switching communication network VoIP and the fresh installation of software on a communication component, the communication components in the packet-switching communication network VoIP regularly send special search messages which, in a similar manner to the method described, are likewise forwarded from one communication component to the next and which are used by the communication components for actively searching the packet-switching communication network VoIP for suitable newer control software. Such search messages are also received by communication components on which a special server component is installed, which are provided for distributing software updates in the packet-switching communication network VoIP. In this way, it is possible to provide software updates at any point in the packet-switching communication network VoIP and to distribute them on the basis of the “snowball” principle.

1-11. (canceled)

12. A method for updating a service in a communication network containing a plurality of communication components which use and provide the service in the network, comprising:
providing an identical software-controlled service by the components;
determining the service provided in the communication network by the components;
interchanging and comparing information about a release of the software controlling the service by the components when the service provided by the components is identical; and
initializing a software update when a the comparison identifies that the releases are different.

13. The method as claimed in claim 12, wherein software is sent from the component with a more up-to-date release to the component with an earlier release.

14. The method as claimed in claim 12, wherein software with a more up-to-date release is sent from a third communication component providing this software to the component with an earlier release.

15. The method as claimed in one of claims 12, wherein the comparison is repeated at settable time intervals.

16. The method as claimed in one of claims 12, wherein the network includes a packet-switching network.

17. The method as claimed in one of claims 12, wherein the services are selected from the group consisting of gateway functionality, voicemail server, and address server.

18. A method for updating a service in a communication network, comprising:
providing the service in the communication network with a plurality of communication components, the components capable of providing an identical software-controlled service;
activating the service in a second communication component by a first communication component; and
updating software pertaining to the service on the second component when the service is not provided by software on the second component.

19. The method as claimed in claim 18, wherein the service is provided by the first component

20. The method as claimed in claim 19, wherein the software pertaining to the service is sent from the first component to the second component

21. The method as claimed in claim 18, wherein the software pertaining to the service the is sent from a third communication component to the second component.

22. The method as claimed in claim 18, wherein the update is performed if the component receiving the update has hardware capable of running the software to be received.

23. The method as claimed in claim 18, wherein the updated software can be retrieved by further communication components and their services.

24. The method as claimed in claim 18, wherein at least one communication component in the communication network holds software in a respective up-to-date release ready for retrieval for a plurality of services of different types.

25. A method for updating a service in a packet-switching communication network, comprising:
providing an identical software-controlled service on a first servent communication component and a second servent communication component, the components communicating peer-to-peer;
determining the service provided in the communication network by the first and second components;
interchanging and comparing release information of the software controlling the service by the first and second components when the service is identical;
comparing the release information of the first and second components; and
if the releases are different the method further comprising:
identifying a more up-to-date component selected from the group consisting of the first component and the second component and a earlier component selected from the group consisting of the first component and the second component and
initiating a software update if the earlier component has the hardware capable of running the software of the more up-to-date component.

26. The method as claimed in claim 25, wherein the first and second servent communication components include server and client functionality.

27. The method as claimed in claim 25, wherein the software is sent from the more up-to-date component to the earlier component.

28. The method as claimed in claim 25, wherein the software is sent from a third servent communication to the component with an earlier release.

29. The method as claimed in claim 25, wherein the comparison of the release information is repeated at settable time intervals.
